(19) United States
(12) Patent Application Publication
(10) Pub. No.: US 2023/0011547 A1
(43) Pub. Date: Jan. 12, 2023

(54) OPTIMIZING CONTINUOUS MEDIA COLLECTION

(71) Applicants: Getac Technology Corporation, Taipei City (TW); WHP Workflow Solutions, Inc., North Charleston, SC (US)

(72) Inventors: Thomas GUZIK, Edina, MN (US); Muhammad ADEEL, Edina, MN (US)

(21) Appl. No.: 17/373,238

(22) Filed: Jul. 12, 2021

(51) Int. Cl. H04N 7/18; G11B 27/34

(52) U.S. Cl. CPC H04N 7/183; G11B 27/34

(57) ABSTRACT

Described herein are techniques that may be used to identify a portion of media data to be prioritized. Such techniques may comprise receiving, from a media collection device, media information that includes a first media data and at least one of trigger data or sensor data, determining, based on one or more of the trigger data or the sensor data, that a portion of the first media data is to be prioritized, identifying, based on one or more of the trigger data or the sensor data, a beginning and end time to be associated with a second media data that includes the portion of the first media data, and generating the second media data from the received first media data based on the beginning and ending time, the second media data including less than the entirety of the first media data.

### BACKGROUND

In recent years, a number of events have highlighted the need for increased recordkeeping for law enforcement officers. This need pertains to evidentiary collection as well as protecting the public from potential abuses by a police officer and protecting the police officer from false accusations of abuse. Law enforcement has previously used various camera devices, such as patrol vehicle cameras and body mounted cameras, as a means of reducing liability and documenting evidence.

In the case of body camera usage by law enforcement officers, such officers may record only a portion of the media content relevant to an incident. In some cases, this may result from the officer not remembering to activate his or her body-mounted camera when the incident first begins. In other cases, this may result from the officer not wanting a record of the incident to be collected. However, neither of these cases are in the best interests of the law enforcement agency.

### SUMMARY

Techniques are provided herein for identifying a portion of media content received from a media collection device to be prioritized. In such techniques, a media collection device may provide information to a media processing platform that includes media content and a combination of trigger data and/or sensor data. The media processing platform may generate a portion of the media content to be prioritized based on trigger data and/or sensor data.

In one embodiment, a method is disclosed as being performed by a media processing platform, the method comprising receiving, from a media collection device, media information that includes media content and at least one of trigger data or sensor data, determining, based on one or more of the trigger data or the sensor data, that a portion of the media content is to be prioritized, identifying, based on one or more of the trigger data or the sensor data, a beginning and end time to be associated with the portion of the media content, and generating the portion from the received media content based on the beginning and ending time.

An embodiment is directed to a computing device comprising: a processor; and a memory including instructions that, when executed with the processor, cause the computing device to receive, from a media collection device, media information that includes media content, trigger data, and sensor data, determine, based on one or more of the trigger data or the sensor data, that a portion of the media content is to be prioritized, identify, based on one or more of the trigger data or the sensor data, a beginning and end time for the portion of the media content, and generate the portion from the received media content based on the beginning and end time.

An embodiment is directed to a non-transitory computer-readable media collectively storing computer-executable instructions that upon execution cause one or more computing devices to perform acts comprising receiving, from a media collection device, media information that includes media content, trigger data, and sensor data, determining, based on one or more of the trigger data or the sensor data, that a portion of the media content is to be prioritized, identifying, based on one or more of the trigger data or the sensor data, a beginning and end time for the portion of the media content, and generating the portion from the received media content based on the beginning and end time.

The foregoing, together with other features and embodiments, will become more apparent upon referring to the following specification, claims, and accompanying drawings.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates a computing environment in which media content generated by one or more media collection devices is stored and processed in accordance with at least some embodiments;

FIG. 2 is a block diagram showing various components of a computing system architecture that supports prioritization of portions of media content in accordance with some embodiments;

FIG. 3 depicts a block diagram showing an example process flow for identifying a portion of media content in accordance with embodiments;

FIG. 4 depicts an illustration of a portion of a media content identified from a media content in accordance with some embodiments;

FIG. 5 depicts a block diagram showing an example process flow for automatically identifying a portion of media content to be prioritized in accordance with embodiments; and

FIG. 6 illustrates an exemplary overall training process of training a machine learning model to detect events in media data based on sensor and/or trigger data, as well as content in the media data, in accordance with aspects of the disclosed subject matter.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Described herein are techniques that may be used to identify a portion of media content received from a media collection device to be prioritized. In such techniques, a media collection device may provide information to a media processing platform that includes media content and a combination of trigger data and/or sensor data. The media processing platform may determine, based on the received information that a portion of the media content is to be prioritized. In some embodiments, such a determination may be made based on trigger data that includes an indication that a trigger mechanism has been activated by an operator of the media collection device. In some embodiments, such a determination may be made based on detecting an event associated with the media content. An event may be determined upon detecting one or more data patterns in the received sensor data.

Once a determination has been made that a portion of the media content is to be prioritized, bounds of such a portion are determined. This may comprise determining a beginning time and an ending time for the portion. In some embodiments, a beginning time and/or ending time may be determined to correspond to the occurrence of an activation trigger or a detected event. In some cases, one or more of a beginning time or ending time may be offset from occurrence of an activation trigger or a detected event by a predetermined amount of time. Once a beginning time and ending time have been identified, a duplicate portion of media content may be generated corresponding to the period of time between that beginning time and ending time. The duplicate portion of media data may be prioritized by applying a different retention policy to that portion of the media data than is applied to the media data as a whole.

When a body camera is used to continuously capture media data, such as video data that is stored within a secure data store, that video data may become hard to analyze using conventional systems. In order to identify a particular portion of the video data that is of interest to a user (e.g., a reviewer), that user may have to review a large section (potentially hours) of video imagery of the video data. Even if the user views this video imagery at an increased speed, this can be a huge drain on resources.

Embodiments of the disclosure provide several advantages over conventional techniques. For example, embodiments of the proposed system provide for automatic prioritization of selections of media content. This allows an interested party to retrieve relevant portions of a video or other media data without having to review the media data in its entirety. Additionally, prioritized portions of media data, generated from the media data, can be stored separately for a longer period of time than the underlying media data, allowing for better allocation of memory resources.

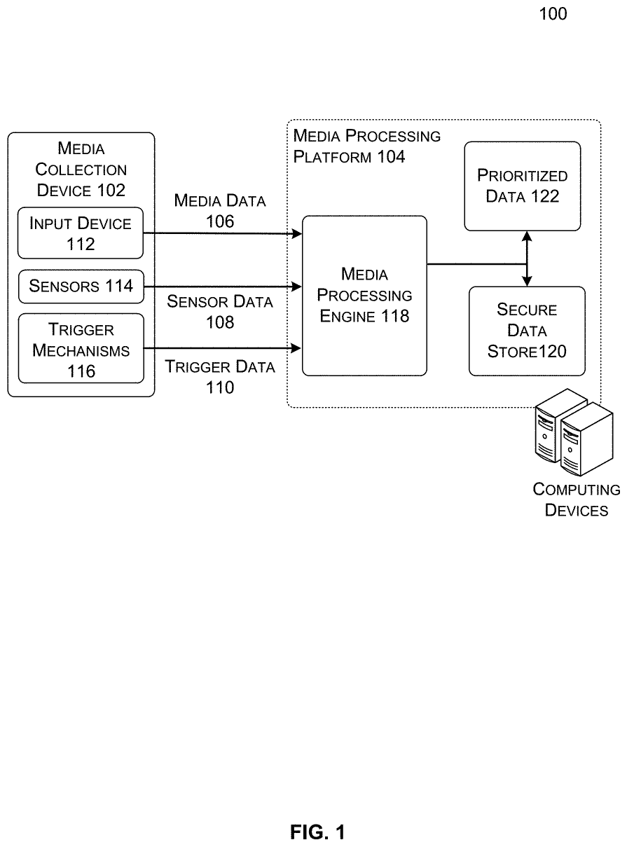

FIG. 1 illustrates a computing environment in which media content generated by one or more media collection devices is stored and processed in accordance with at least some embodiments. As depicted in FIG. 1, a computing environment 100 may include one or more media collection devices, including media collection device 102, configured to communicate with a media processing platform 104 that may comprise a number of computing devices. In the computing environment 100, the media collection device may be configured to transmit some combination of media data 106, sensor data 108, and trigger data 110 to the media processing platform.

In the computing environment 100 depicted in FIG. 1, a media collection device 102 may comprise any suitable electronic device capable of being used to collect media data related to an environment surrounding the media collection device. In some cases, the media collection device may be a camera mounted within a vehicle. In some cases, the media collection device may be a device that is capable of being worn or otherwise mounted or fastened to a person. The media collection device 102 may include at least one input device 112, one or more sensors 114, and one or more trigger mechanisms (triggers) 116.

An input device 112 may include any electronic component capable of collecting media data (e.g., audio data and/or visual data) pertaining to an environment in which the media collection device is located. In some non-limiting examples, an input device may include a camera for collecting imagery data and/or a microphone for collecting audio data.

The number of sensors 114 may include one or more electronic components capable of obtaining information about a status of the media collection device. In some embodiments, the number of sensors 114 may include a temperature sensor, a real-time clock (RTC), an inertial measurement unit (IMU), or any other suitable sensor. An IMU may be any electronic device that measures and reports a body's specific force, angular rate, and sometimes the orientation of the body, using a combination of accelerometers, gyroscopes, and magnetometers.

A trigger mechanism 116 may include any electronic component capable of obtaining an indication from a user of an action to be performed. In some cases, such an action may include an action to generate an indicator for an event to be associated with collected media data with respect to a point in time or a range of times. In a non-limiting example, a trigger mechanism may include a switch or a button located on the media collection device.

The media collection device may be configured to transmit media data to the media processing platform 104. More particularly, the media collection device may be configured to transmit media data 106 captured by the input device to the media processing platform via an established communication session. Media data 106 may comprise any suitable series of data samples collected via any suitable type of input device. For example, the media collection device may be configured to transmit streaming video and/or audio data to the media processing platform. In another example, the media collection device may be configured to transmit a series of still images captured at periodic intervals.

In some embodiments, the media collection device may be further configured to transmit sensor data 108 captured by the one or more sensors 114 to the media processing platform. Sensor data 108 may include any suitable data collected in relation to environmental factors affecting the media collection device. For example, the media collection device may transmit information about movements and/or orientations of the media collection device. Such sensor data may be transmitted as associated with the media data (e.g., as metadata) or separate from the media data. Each of the media data and sensor data may include timing information that may be used to correlate the two types of data.

In some embodiments, the media collection device 102 may be further configured to transmit trigger data 110 captured by the one or more trigger mechanisms 116 to the media processing platform. In some embodiments, such trigger data may include an indication of a button push or other suitable trigger activation resulting from a user's activation of a trigger mechanism. Often, though not exclusively, trigger data corresponds to a human interaction with the media collection device with an intent to trigger or indicate the start of an event or a potential event.

The media processing platform 104 can include any computing device configured to perform at least a portion of the operations described herein. Media processing platform 104 may be composed of one or more general purpose computers, specialized server computers (including, by way of example, PC (personal computer) servers, UNIX™ servers, mid-range servers, mainframe computers, rack-mounted servers, etc.), server farms, server clusters, or any other appropriate arrangement and/or combination. Service provider computer 108 can include one or more virtual machines running virtual operating systems, or other computing architectures involving virtualization such as one or more flexible pools of logical storage devices that can be virtualized to maintain virtual storage devices for the computer.

In some embodiments, the media processing platform 104 may maintain a media processing engine 118 configured to determine retention policies to be applied to media data. In some embodiments, media data received by the media processing platform 104 is maintained within a secure data store 120 that includes media data received from a number of different media collection devices. In some embodiments, upon receiving a particular trigger data or type of trigger data in relation to received media content, the media processing engine may determine one or more procedures or policies to be applied to a portion of the media data identified based on the trigger data.

Upon receiving sensor and/or trigger data from the media collection device, the media processing engine may be configured to correlate patterns of the sensor and/or trigger data to particular events. For example, this may comprise identifying particular patterns of movements attributed to the media collection device from the sensor data 108. In another example, this may comprise identifying particular objects or types of objects that are depicted within the received media data 106 (e.g., using one or more object recognition techniques). In another example, this may comprise identifying particular audio cues (e.g., spoken words or phrases) within the media data.

For illustration purposes, consider a scenario in which the media collection device is a body-mounted camera worn by a law enforcement officer and the media processing platform is a server that is located remote from the body-mounted camera. In some cases, it may be in the best interests of the law enforcement agency to issue to its officers body-mounted cameras that constantly collect media data (e.g., the wearer is unable to prevent collection of data) while the body-mounted camera is operating. While these body-mounted camera devices may include a record button, that button may not actually prevent the collection of media content using the device. In this scenario, the body-mounted camera device may constantly transmit information, i.e., media data, to the media processing platform via a communication session established over a long-range communication channel. Particularly, the body-mounted camera device may collect video data (i.e., media data) and transmit that video data to the media processing platform along with positional information (i.e., sensor data) received from one or more sensors installed in the body-mounted camera device and/or trigger data received from one or more trigger mechanisms installed in the body-mounted camera device. The positional information may indicate a change in position or orientation of the body-mounted camera device. The trigger data may indicate one or more button/switch activations made by the operator of the body-mounted camera device (e.g., a pressing of the record button).

Continuing with the above scenario, the body-mounted camera may continue to collect and transmit media data to the media processing platform while the body-mounted camera is in operation (e.g., upon detecting that it has been mounted and/or powered on). In this scenario, the law enforcement officer may, while operating the body-mounted camera, begin to run. Information from accelerometers and/or other sensors may be transmitted, as sensor data, to the media processing platform along with the media data captured by the body-mounted camera. The media processing platform may then interpret the sensor data (e.g., using a trained machine learning model) to make a determination that the officer has begun to run and may mark the media data with a time at which the officer was determined to have begun running. Additionally, subsequent to the officer beginning to run, the officer may press a record button on the image capture device. The pressing of this button may then cause the media collection device to generate trigger data associated with the pressing of that button. Upon receiving the trigger data, the media processing platform may identify a portion of the media data to be stored in a prioritized data store, including having a higher retention range then other stored media data. In some cases, the identified portion of the media data may include a portion of the media data beginning a predetermined amount of time (e.g., five minutes) before the trigger data was received. In some cases, if the trigger data is received in conjunction with (e.g., shortly before or after) an identification of an event based on the sensor data (e.g., officer running), then the identified portion of the media data may include a portion of the media data beginning a predetermined amount of time before the trigger activation or the event (e.g., whichever occurred first).

In some embodiments, communication between one or more components as described with respect to the computing environment 100 can be facilitated via a network or other suitable communication channel. Such a network can include any appropriate network, including an intranet, the Internet, a cellular network, a local area network or any other such network or combination thereof. A suitable communication channel may include any suitable standard for the short-range wireless interconnection of mobile phones, computers, and other electronic devices. Components used for such a system can depend at least in part upon the type of network and/or environment selected. Protocols and components for communicating via such a network may be known to one skilled in the art and will not be discussed herein in detail. Communication over the network can be enabled by wired or wireless connections and combinations thereof.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

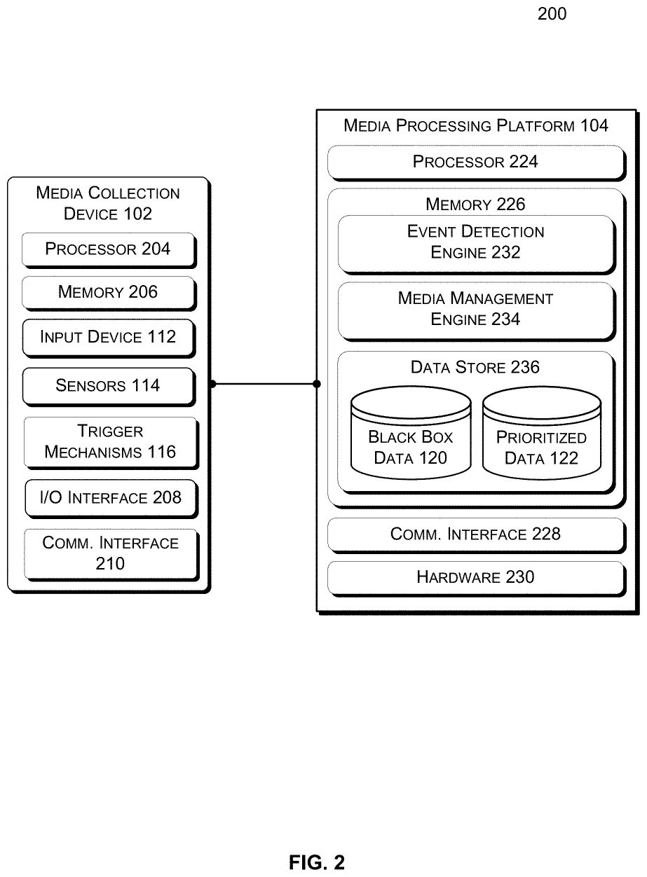

FIG. 2 is a block diagram showing various components of a computing system architecture that supports prioritization of portions of media content in accordance with some embodiments. The computing system architecture 200 may include at least one or more media collection devices 102 and a media processing platform 104 that comprises one or more computing devices.

A media collection device 102 may be any suitable electronic device capable of obtaining and recording situational data and that has communication capabilities. The types and/or models of media collection device may vary. The media collection device may include at least a processor 204, a memory 206, an input device 112, one or more sensors 114, and one or more trigger mechanisms 116.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

As noted elsewhere, a media collection device may include one or more input devices 112 as well as one or more sensors 114 and one or more trigger mechanisms 116. An input device 112 may include any device capable of obtaining imagery and/or audio. For example, the input device may include a camera device capable of capturing image data and/or a microphone device capable of capturing audio data. In some embodiments, the input device may be configured to capture streaming media data (audio and/or video) to be provided to the media processing platform. In some embodiments, the input device may be configured to capture media data, such as still images, at periodic intervals. In some cases, the captured media data may be stored locally on the media collection device and uploaded to the media processing platform when a communication channel is established between the two. In some cases, the captured media data may be transmitted to the media processing platform in real-time (e.g., as the media data is captured).

Each media collection device may include an input/output (I/O) interface 208 that enables interaction between the media collection device and a user (e.g., its wearer). Additionally, the media collection device may include a communication interface 210 that enables communication between the media collection device and at least one other electronic device (e.g., the media processing platform). Such a communication interface may include some combination of short-range communication mechanisms and long-range communication mechanisms. For example, the media collection device may connect to one or more external devices in its proximity via a short-range communication channel (e.g., Bluetooth®, Bluetooth Low Energy (BLE), WiFi, etc.) and may connect to the media processing platform via a long-range communication channel (e.g., cellular network).

The media processing platform 104 can include any computing device or combination of computing devices configured to perform at least a portion of the operations described herein. The media processing platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The media processing platform 104 can include one or more virtual machines running virtual operating systems, or other computing architectures involving virtualization such as one or more flexible pools of logical storage devices that can be virtualized to maintain virtual storage devices for the computer. For example, the media processing platform 104 may include virtual computing devices in the form of virtual machines or software containers that are hosted in a cloud.

The media processing platform 104 may include one or more processors 224, memory 226, a communication interface 228, and hardware 230. The communication interface 228 may include wireless and/or wired communication components that enable the media processing platform 104 to transmit data to, and receive data from, other networked devices, such as receiving media data from a media collection device 102. The hardware 230 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The one or more processors 224 and the memory 226 may implement functionality from one or more software modules and data stores. Such software modules may include routines, program instructions, objects, and/or data structures that are executed by the processors 224 to perform particular tasks or implement particular data types. The memory 226 may include at least a module for detecting events based on received sensor data (e.g., event detection engine 232) as well as a module for managing the collection, storage, and use of media data (e.g., media management engine 234). Additionally, the memory 226 may further maintain a data store 236 that includes one or more database tables. Particularly, the data store 236 may include a database of media content received from one or more media collection devices for short-term storage (e.g., secure data 120) as well as a database of media content selected for long-term storage (e.g., prioritized data 122).

In some embodiments, the event detection engine 232 may be configured to, in conjunction with the processor 224, identify particular events captured within a media content and to categorize and index those events. In some embodiments, this comprises receiving media content from a media collection device as well as sensor data corresponding to that media content. An event may be identified based on data patterns detected form an analysis of sensor data. For example, given a scenario in which the media collection device is being operated by a law enforcement officer, the event detection engine may detect data patterns that indicate that the officer has become prone, has started running, has turned (or otherwise repositioned) suddenly, or performed another suitable action based on the received sensor data. In some cases, the data patterns may exhibit accelerometer data that indicates sudden accelerations corresponding to those typical of running. In some cases, data patterns may exhibit gyroscope data that corresponds to those of a prone operator. An event may be generated for each of these detected actions/conditions.

In some embodiments, an event may be detected via the event detection engine upon on detecting particular objects or object types within the media data. This may comprise the use one or more object recognition techniques to identify one or more objects depicted within received media data. The one or more object recognition techniques may include such techniques as edge detection, spatial pyramid pooling, Region-Based Convolutional Network (e.g., R-CNN), Histogram of oriented gradients (HOG), Region-based Fully Convolutional Networks (R-FCN), Single Shot Detector (SSD), Spatial Pyramid Pooling (SPP-net), or any other suitable technique for identifying an object within media data. In some embodiments, this may comprise the use of one or more trained machine learning models that are specifically trained to identify one or more objects within media data. For example, such machine learning models may be trained by providing images of known objects (i.e., inputs) as well as feedback (i.e., outputs) in the form of object identifications. Suitable objects to be identified may include vehicles, persons, weapons, or any other suitable object type.

In some embodiments, the media management engine 234 may be configured to, in conjunction with the processor 224, identify a portion of the media data as well as one or more actions to be taken with respect to that portion of the media data. In some embodiments, a portion of media data may be selected from received media content based on trigger data received from a media collection device. In some embodiments, a portion of media data may be selected from received media data based on one or more events detected within the media data. In some embodiments, a portion of media data may be selected from received media data based on a combination of trigger data and events detected within the media content (e.g., via event detection engine 232).

In some embodiments, the media management engine 234 is configured to identify a portion of received media data that may be relevant to an incident. Such a portion of the media data may be identified as being correlated to a particular incident. The portion of media data may be identified based on a range of times determined to be associated with an incident. Such a range of times may be determined based on at least one or trigger data and/or information about an event determined to be associated with the media content. A range of times may include a beginning time and an ending time for the portion of the media data.

In some embodiments, at least one of the beginning time and/or end time may be determined based on trigger data received from the media collection device along with the media data. For example, a beginning time for the portion of media data may correspond to a time of an activation of a trigger mechanism by a user of the media collection device. In this example, an ending time for the portion of media data may correspond to a time of a deactivation of a trigger mechanism by a user of the media collection device. A beginning time and/or ending time may be an actual time or a relative time (e.g., elapsed time from the start of the media content).

In some embodiments, at least one of the beginning time and/or ending time may be determined based on sensor data received from the media collection device. For example, one or more events may be identified as being associated with the media data based on a data pattern detected within received sensor data. In this example, a beginning time may be determined based on a time determined for the beginning of the detected event. Additionally, an ending time may be determined based on based on a time determined for the ending of the detected event.

In some embodiments, a beginning time and/or ending time may be determined based on a combination of trigger data and sensor information. For example, the media management engine 212 may, upon receiving trigger data, determine a time at which a user has activated a particular trigger mechanism on a media collection device. Upon making such a determination, the media management engine may identify one or more ongoing events associated with the media data based on sensor data also received from the media collection device. A beginning time for the portion of the media data may then be determined based on a beginning time associated with the one or more ongoing events.

In some embodiments, a determination may be made to select a portion of media data to be prioritized absent receiving any trigger data from the media collection device. Such a determination may be made upon detecting, based on sensor data received from the media collection device, an event or combination of events that warrants such prioritization. In some embodiments, particular event types may always warrant prioritization such that a portion of media data may be prioritized any time that an event of the event type is detected within the sensor data. For example, in the case that the body-mounted camera is used by law enforcement officers, prioritization may be warranted any time that an audio data pattern within the received media data is received that correlates to (e.g., to a threshold degree of similarity) an exclamation of “officer down” by an operator of the media collection device. In this example, a portion of the media data may be selected for prioritization even if the operator of the device never initiates recording (e.g., via an activation trigger mechanism). In some embodiments, a ranking value or score may be determined based on weighted values for one or more events detected based on the sensor data. In these embodiments, a portion of the media data may be selected for prioritization if the ranking value is greater than some threshold value even if the operator of the device never initiates recording. For example, a weighted value may be assigned to each event type. If multiple events are determined as occurring at a time or range of times with respect to a media data, then a ranking value may be determined for that time or range of times as a sum of the weighted values for the occurring events. If that ranking value exceeds a predetermined threshold value, then a portion of the media data that includes the time or range of times may be selected for prioritization.

The communication interface 228 may include wireless and/or wired communication components that enable the media processing platform to transmit or receive data via a network, such as the Internet, to a number of other electronic devices (e.g., media collection device 102). Such a communication interface 202 may include access to both wired and wireless communication mechanisms. In some cases, the media processing platform transmits data to other electronic devices over a long-range communication channel, such as a data communication channel that uses a mobile communications standard (e.g., long-term evolution (LTE)).

The hardware 230 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

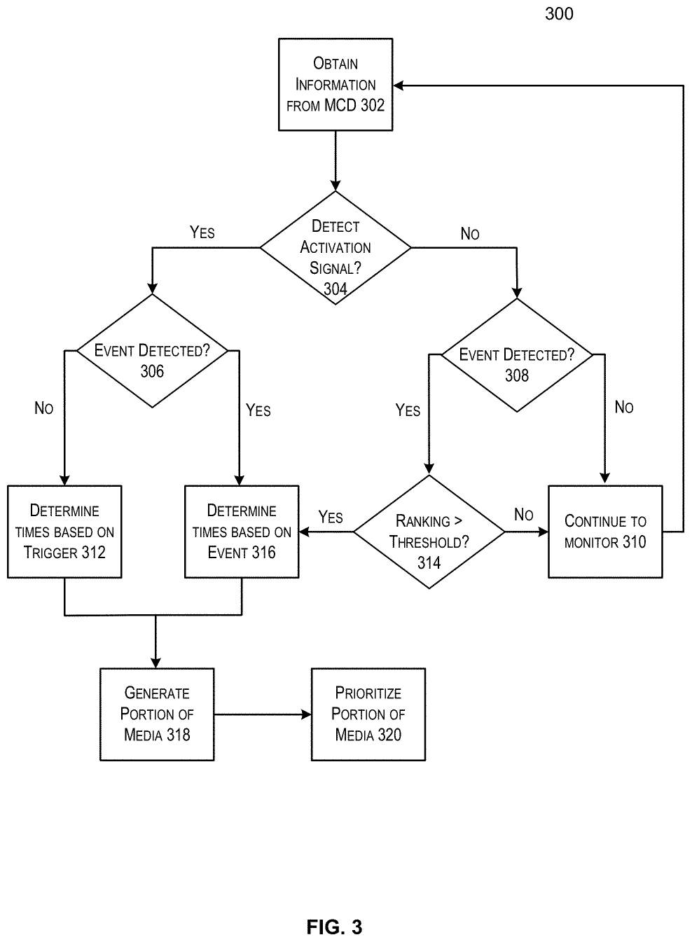

FIG. 3 depicts a block diagram showing an example process flow for identifying a portion of media data in accordance with embodiments. The process 300 involves interactions between various components of the architecture 100 described with respect to FIG. 1. More particularly, the process 300 involves interactions between at least a media processing platform 104 and a media collection device 102.

At 302 of the process 300, information may be received from a media collection device (MCD). Such information may include one or more of media data, sensor data, and/or trigger data collected by the media collection device. Media data may comprise any suitable data depicting an environment in which the media collection device is located. In some embodiments, media data may comprise video and/or audio data collected by the media collection device. Sensor data may comprise any suitable information indicative of a position, orientation, or movement of the media collection device. Trigger data may include any information indicative of an activation of one or more trigger mechanism on the media collection device.

At 304 of the process 300, a determination may be made as to whether an activation signal has been detected. The determination may be made based on detecting an activation signal within the received trigger data that is indicative of an activation of a button or other trigger mechanism by an operator of a media collection device.

Whether or not an activation signal is detected at 304, a determination may also be made as to whether an event is detected based on the received sensor data at 306 or 308. In some embodiments, such a determination may be made based on data patterns detected within the sensor data that match data patterns associated with events or event types. The determination may be made upon providing the sensor data to a machine learning model that has been trained to correlate data patterns with events. In some embodiments, an event may be detected upon detecting one or more objects within the media data. For example, a specific object or type of object may be detected within image or video data (i.e., the media data). In another example, a specific word or phrase may be detected within audio data.

Upon a determination being made that no activation signal has been detected (e.g., “No” from decision block 304) and that no events have been detected based on the sensor data (e.g., “No” from decision block 308), the process 300 may comprise continuing to monitor information and/or data received from the media collection device at 310.

In some cases, the process may comprise identifying a portion of the media data to be selected for prioritization. In these cases, the process may comprise determining a beginning time and an ending time for the portion of media data. Upon a determination being made that an activation signal has been detected (e.g., “Yes” from decision block 304) and that no events have been detected based on the sensor data (e.g., “No” from decision block 308), the process 300 may comprise determining at least a beginning time and ending time based on the received trigger data at 312. For example, a beginning time for the portion of media data may be determined to correspond to a time at which an activation signal (e.g., a signal corresponding to an activation of a trigger mechanism) is received. In another example, a beginning time for the portion of media data may be determined to be offset from a time at which an activation signal is received. By way of illustration, a beginning time may be determined to be five minutes prior to the time at which an activation signal is received.

Upon a determination being made that no activation signal has been detected (e.g., “No” from decision block 304) and that at least one event has been detected based on the sensor data (e.g., “Yes” from decision block 308), the process 300 may comprise further determining whether a ranking value associated with the detected events is greater than a predetermined threshold value at 314. In some embodiments, each of the detected events may be assigned a weighted value. A ranking value may be determined by calculating a sum of each of the weighted values assigned to each of the detected events. If the ranking value is not greater than the threshold value (e.g., “No” from decision block 312) then the process 300 may comprise continuing to monitor data received from the media collection device at 310.

Upon a determination being made that an activation signal (trigger data) has been detected (e.g., “Yes” from decision block 304) and that at least one event has been detected based on the sensor data (e.g., “Yes” from decision block 308), or upon determining that the ranking value is greater than the threshold value (e.g., “Yes” from decision block 314), the process 300 may comprise determining at least a beginning time and ending time based on the determined event at 316. For example, a beginning time for the portion of media data may be determined to correspond to a time at which an event is determined to have occurred. In another example, a beginning time for the portion of media data may be determined to be offset from a time at which the event is determined to have occurred. By way of illustration, a beginning time may be determined to be five minutes prior to the time at which the event is determined to have occurred.

At 318, the process 300 comprises generating the portion of the media data based on the determined beginning time and ending time. In some embodiments, the portion of the media data is generated by duplicating the media data occurring between the beginning time and the end time. In some embodiments, the duplicated media data may be provided to a codec (e.g., a video codec). In those embodiments, a video codec may be used to compress the duplicated media data into a format that conforms to a standard video coding format.

At 320, the process 300 comprises prioritizing the generated portion of media data. In some embodiments, prioritizing the portion of media data may comprise applying a retention policy to the portion of the media data that is different from the retention policy applied to the media data. The retention policy applied to the portion of media data may cause that portion to be retained for a longer period of time than the media data, as a whole, is retained. In some cases, information associated with a trigger and/or a determined event may be associated with the media data. For example, such information may be appended to the media data as metadata.

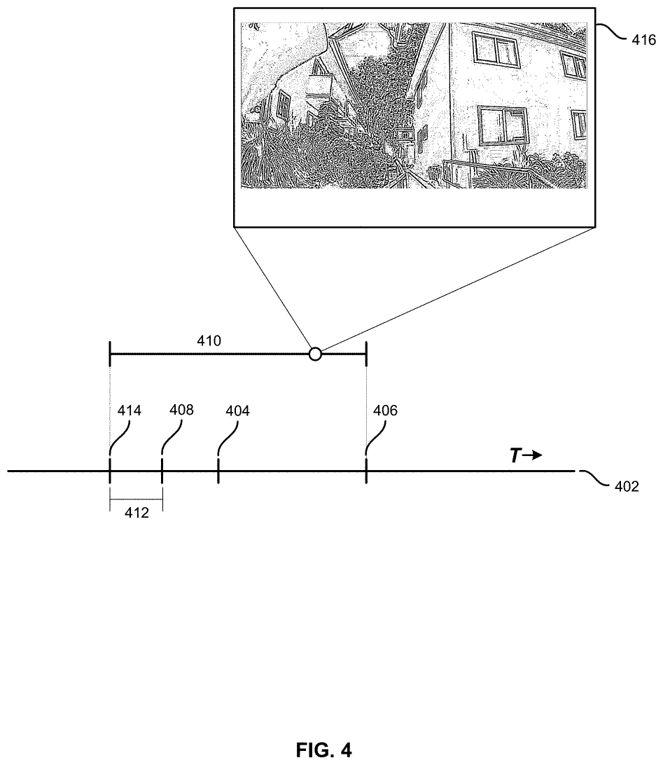

FIG. 4 depicts an illustration of a portion of a media content identified from a media content in accordance with some embodiments. Each media data received from a media collection device may be associated with a timeline 402. Various timestamps may be associated with the timeline 402, each of which is associated with a trigger and/or a determined event.

In some embodiments, the timeline may include at least a timestamp 404 associated with an activation trigger signal and a timestamp 406 associated with a deactivation trigger signal. An activation trigger signal may correspond to a signal received from a media collection device indicative that a trigger mechanism associated with device activation has been activated on the media collection device. A deactivation trigger signal may correspond to a signal received from a media collection device indicative that a trigger mechanism associated with device deactivation has been activated on the media collection device.

In some embodiments, the timeline may further include a timestamp 408 associated with an event. Such a timestamp 408 may be determined upon on detecting a data pattern matching an event within sensor data received from the media collection device. In some embodiments, multiple events may be determined from the sensor data based on data patterns detected within the sensor data.

A portion 410 may be selected from the media content received from a media collection device upon identifying a beginning timestamp and an ending timestamp for that portion. In some cases, a beginning timestamp or ending timestamp may correspond to the timestamps on the timeline. For example, a beginning timestamp may correspond to a time on the timeline at which a data pattern is first detected as corresponding to an event. Similarly, an ending timestamp may correspond to a time on the timeline at which the data pattern corresponding to an event is determined to have ended.

In some embodiments, a beginning timestamp or ending timestamp may be offset from timestamps on the timeline by a predetermined amount of time 412. For example, upon determining that a portion of the media data should be identified (e.g., upon receiving an activation trigger signal), the earliest timestamp of potential timestamps may be determined (e.g., timestamp 408). A beginning timestamp 414 may then be identified as occurring on the timeline the predetermined amount of time 412 before the timestamp 408.

In embodiments, the media data may comprise a video file captured by the media collection device. Such a video file may include a series of video frames 416, each of which corresponds to a time on the timeline. The media data may be played to a user via a media player application installed upon a computing device. In some embodiments, the media data is received from the media collection device in real-time (e.g., as the media data is obtained or captured) as streaming video content.

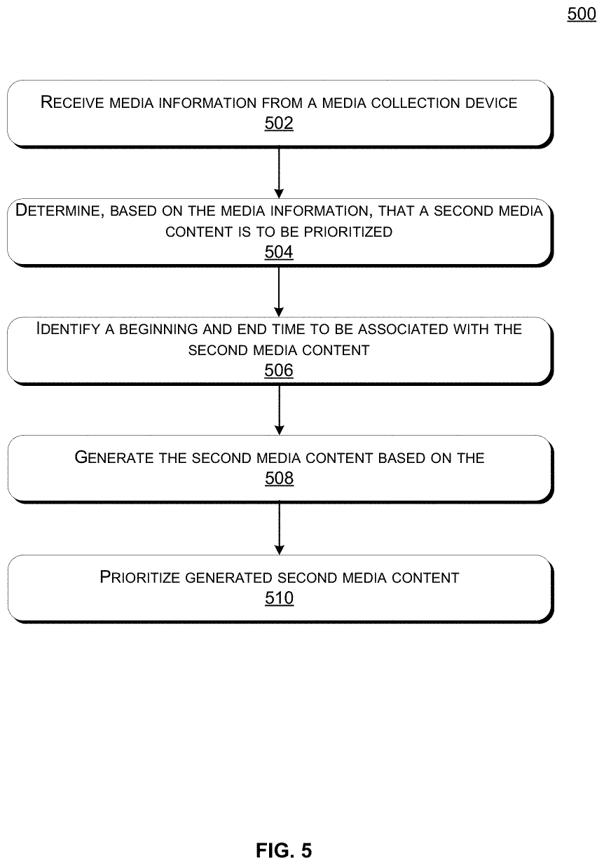

FIG. 5 depicts a block diagram showing an example process flow for automatically identifying a portion of media data to be prioritized in accordance with embodiments. The process 500 may be performed by components within a system 100 as discussed with respect to FIG. 1 above. For example, the process 500 may be performed by a media processing platform 104 in communication with a number of media collection devices 102.

At 502, the process 500 comprises receiving, from a media collection device, media information that includes media data and at least one of trigger data or sensor data corresponding to the media collection device. In some embodiments, the media data comprises streaming video data. In some embodiments, the trigger data comprises an indication that a trigger mechanism has been activated by an operator of the media collection device. In some embodiments, the sensor data comprises data obtained from at least one of a gyroscope, accelerometer, or magnetometer of the media collection device.

At 504, the process 500 comprises making a determination, based on one or more of the trigger data or the sensor data, that a second media data (e.g., a portion of the received media data) is to be prioritized. In some embodiments, determining that a portion of the media data is to be prioritized comprises identifying at least one event associated with the second media data based on data patterns detected in the sensor data. In some embodiments, identifying at least one event associated with the second media data comprises providing the sensor data to a machine learning model trained to correlate data patterns within the sensor data with events.

At 506, the process 500 comprises identifying, based on one or more of the trigger data or the sensor data, a beginning and ending time to be associated with the second media data. In some embodiments, at least one of the beginning time or the ending time is determined based on a time at which the at least one event is determined to have occurred. In some embodiments, the beginning time is determined according to a predetermined amount of time before the time at which the at least one event is determined to have occurred. In some embodiments, the predetermined amount of time is determined based on a type of the at least one event. For example, each event may be associated with a particular amount of time, such that the predetermined amount of time corresponds to the particular amount of time associated with the detected event.

At 508, the process 500 comprises generating the second media data from the received media data based on the beginning and ending time. In some embodiments, generating the second media data comprises duplicating data included in the received media data between the beginning time and the ending time.

At 510, the process 500 comprises prioritizing the generated second media data. In some embodiments, prioritizing the generated second media data comprises applying a first retention policy to the second media data that is different from a second retention policy applied to the media data. In some embodiments, the second media data is associated with at least a portion of the trigger data or the sensor data. For example, a portion of the trigger data or the sensor data may be appended to the second media data as metadata.

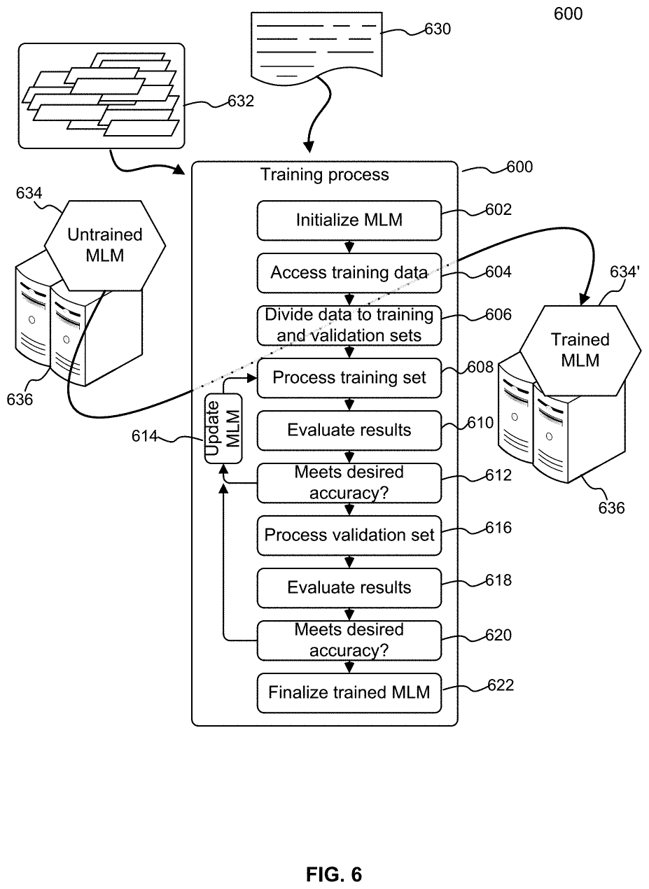

FIG. 6 illustrates an exemplary overall training process 600 of training a machine learning model to detect events in media data based on sensor and/or trigger data, as well as content in the media data, in accordance with aspects of the disclosed subject matter. Indeed, as shown in FIG. 6, the training process 600 is configured to train an untrained machine learning model 634 operating on a computer system 636 to transform the untrained machine learning model into a trained machine learning model 634′ that operates on the same or another computer system. In the course of training, as shown in the training process 600, at step 602, the untrained machine learning model 634 is optionally initialized with training features 630 comprising one or more of static values, dynamic values, and/or processing information.

At step 604 of training process 100, training data 632, is accessed, the training data corresponding to multiple items of input data. According to aspects of the disclosed subject matter, the training data is representative of a corpus of input data, (i.e., sensor, trigger, and/or media data) of which the resulting, trained machine learning model 634′ will receive as input. As those skilled in the art will appreciate, in various embodiments, the training data may be labeled training data, meaning that the actual results of processing of the data items of the labeled training data are known (i.e., the results of processing a particular input data item are already known/established). Of course, in various alternative embodiments, the corpus 632 of training data may comprise unlabeled training. Techniques for training a machine learning model with labeled and/or unlabeled data are known in the art.

With the training data 632 accessed, at step 606 the training data is divided into training and validation sets. Generally speaking, the items of input data in the training set are used to train the untrained machine learning model 634 and the items of input data in the validation set are used to validate the training of the machine learning model. As those skilled in the art will appreciate, and as described below in regard to much of the remainder of training process 100, in actual implementations there are numerous iterations of training and validation that occur during the overall training of the machine learning model.

At step 608 of the training process, the input data items of the training set are processed, often in an iterative manner. Processing the input data items of the training set include capturing the processed results. After processing the items of the training set, at step 610, the aggregated results of processing the input data items of the training set are evaluated. As a result of the evaluation and at step 612, a determination is made as to whether a desired level of accuracy has been achieved. If the desired level of accuracy is not achieved, in step 614, aspects (including processing parameters, variables, hyperparameters, etc.) of the machine learning model are updated to guide the machine learning model to generate more accurate results. Thereafter, processing returns to step 602 and repeats the above-described training process utilizing the training data. Alternatively, if the desired level of accuracy is achieved, the training process 100 advances to step 616.

At step 616, and much like step 608, the input data items of the validation set are processed, and the results of processing the items of the validation set are captured and aggregated. At step 618, in regard to an evaluation of the aggregated results, a determination is made as to whether a desired accuracy level, in processing the validation set, has been achieved. At step 620, if the desired accuracy level is not achieved, in step 614, aspects of the in-training machine learning model are updated in an effort to guide the machine learning model to generate more accurate results, and processing returns to step 602. Alternatively, if the desired level of accuracy is achieved, the training process 100 advances to step 622.

At step 622, a finalized, trained machine learning model 634′ is generated. Typically, though not exclusively, as part of finalizing the now-trained machine learning model 634′, portions of the now-trained machine learning model that are included in the model during training for training purposes may be extracted, thereby generating a more efficient trained machine learning model 634′.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, from a media collection device, media information that includes a first media data and at least one sensor data;
detecting, based on a data pattern detected within the at least one sensor data, an event associated with the first media data, the data pattern comprising one or more movements and/or orientations of the media collection device, and the at least one event comprises an action to be associated with an operator of the media collection device;
determining, based upon determining that the event warrants prioritization, that a portion of the first media data is to be prioritized based on the detected event;
identifying, based on one or more of the trigger data or the sensor data, a beginning time and ending time for a second media data that includes the portion of the first media data; and
generating the second media data from the first media data based on the beginning time and the ending time, the second media data including less than the entirety of the first media data; and
prioritizing the generated second media data by way of applying a first retention policy to the generated second media data that is different from a second retention policy applied to the first media data, wherein the first retention policy includes instructions to store the generated second media data for long-term storage in a first data store and the second retention policy includes instructions to store the received first media data for short-term storage in a second data store.

2. The method of claim 1, wherein the first media data comprises streaming video data.

3. The method of claim 1, wherein the trigger data comprises an indication that a trigger mechanism has been activated by an operator of the media collection device.

4. The method of claim 1, wherein the sensor data comprises data obtained from at least one of a gyroscope, accelerometer, or magnetometer captured by the media collection device.

5. (canceled)

6. (canceled)

7. The method of claim 1, further comprising associating at least a portion of the trigger data or the sensor data to the second media data.

8. A computing device comprising:
a processor; and
a memory including instructions that, when executed with the processor, cause the computing device to, at least:
receive, from a media collection device, media information that includes a first media data and sensor data;
detect, based on a data pattern detected within the at least one sensor data, at least one event associated with the first media data, the data pattern comprising one or more movements and/or orientations of the computing device, and the at least one event comprises an action to be associated with an operator of the computing device;
determine, based upon determining that the at least one event warrants prioritization, that a portion of the first media data is to be prioritized based on the detected event;
identify, based on one or more of the trigger data or the sensor data, a beginning time and ending time for a second media data that includes the portion of the first media data;
generate the second media data from the first media data based on the beginning time and the ending time, the second media data including less than the entirety of the first media data; and
prioritize the generated second media data by way of applying a first retention policy to the generated second media data that is different from a second retention policy applied to the first media data, wherein the first retention policy includes instructions to store the generated second media data for long-term storage in a first data store and the second retention policy includes instructions to store the received first media data for short-term storage in a second data store.

9. The computing device of claim 8, wherein determining that the event warrants prioritization is based at least in part on an event type of the at least one event associated with the second media data.

10. The computing device of claim 8, wherein at least one event associated with the second media data comprises providing the sensor data to a machine learning model trained to correlate events with data patterns detected within the sensor data.

11. The computing device of claim 8, wherein at least one of the beginning time or the ending time is determined based on a time at which the at least one event is determined to have occurred.

12. The computing device of claim 11, wherein the at least one of the beginning time or the ending time is determined to be a predetermined amount of time before the time at which the at least one event is determined to have occurred.

13. The computing device of claim 12, wherein the predetermined amount of time is determined based on a type of the at least one event.

14. (canceled)

15. (canceled)

16. The computing device of claim 8, wherein the instructions further cause the computing device to associate at least a portion of the trigger data or the sensor data to the second media data.

17. The computing device of claim 8, wherein generating the second media data comprises duplicating data included in the first media data between the beginning time and the ending time.

18. A non-transitory computer-readable media collectively storing computer-executable instructions that upon execution cause one or more computing devices to collectively perform acts comprising:
receiving, from a media collection device, media information that includes a first media data and sensor data;
detecting, based on a data pattern detected within the at least one sensor data, an event associated with the first media data, the data pattern comprising one or more movements and/or orientations of the media collection device, and the at least one event comprises an action to be associated with an operator of the media collection device;
determining, based upon determining that the event warrants prioritization, that a portion of the first media data is to be prioritized based on the detected event;
identifying, based on one or more of the trigger data or the sensor data, a beginning and ending time for a second media data that includes the portion of the first media data;
generating the second media data from the first media data based on the beginning and ending time, the second media data including less than the entirety of the first media data; and
prioritizing the generated second media data by way of applying a first retention policy to the generated second media data that is different from a second retention policy applied to the first media data, wherein the first retention policy includes instructions to store the generated second media data for long-term storage in a first data store and the second retention policy includes instructions to store the received first media data for short-term storage in a second data store.

19. (canceled)

20. (canceled)
